(19) United States
(12) Patent Application Publication
(10) Pub. No.: US 2025/0138984 A1
(43) Pub. Date: May 1, 2025

(54) DEVICE PERFORMANCE ISSUE OPTIMIZATION

(71) Applicant: Apple Inc., Cupertino, CA (US)

(72) Inventors: Abhinav Pathak, Campbell, CA (US); Amit K. Vyas, San Jose, CA (US); Anand Ramadurai, Los Gatos, CA (US); Anca A. Chandra, Los Altos, CA (US); Anshul Dawra, Campbell, CA (US); Ashish Patro, Santa Clara, CA (US); David S. Choi, Cupertino, CA (US); Jonathan Y. Hanna, San Jose, CA (US); Nehal Bhandari, Sunnyvale, CA (US); Ning Ding, San Jose, CA (US); Rohit Mundra, San Jose, CA (US); Ryan A. Carlson, San Diego, CA (US); Xiaomeng Chen, Sunnyvale, CA (US); Yue Li, Cupertino, CA (US); Zoe S. Bohn, Sunnyvale, CA (US)

(21) Appl. No.: 18/384,412

(22) Filed: Oct. 27, 2023

(51) Int. Cl. G06F 11/36

(52) U.S. Cl. CPC G06F 11/3616; G06F 11/3698

(57) ABSTRACT

Methods, systems, and apparatus, including computer programs encoded on computer storage media, for optimizing performance issues. One of the methods includes maintaining, for a plurality of devices at least some of which have different contexts, metric data for an application that executed on each of the plurality of devices; determining, for a metric attribute from a plurality of metric attributes and a subset of the plurality of devices each of which have at least one common context, a potential performance issue for the subset of the plurality of devices using aggregated metric data for the metric attribute; determining, using at least a portion of the aggregated metric data, a portion of a code base or a hardware subcomponent that likely caused the potential performance issue; and providing data for the portion of the code base or the hardware subcomponent that likely caused the potential performance issue.

### BACKGROUND

Software applications can execute on devices used in a variety of contexts. For instance, a particular software application can execute in multiple different countries, with different interfaces for different languages. In some examples, the particular software application can execute on different hardware, different operating systems, e.g., as newer versions of operating systems are released, or a combination of both.

### SUMMARY

In general, one aspect of the subject matter described in this specification can be embodied in methods that include the actions of maintaining, for a plurality of devices at least some of which have different contexts from a plurality of contexts, metric data for an application that executed on each of the plurality of devices; determining, for a metric attribute from a plurality of metric attributes and a subset of the plurality of devices each of which have at least one common context from the plurality of contexts, a potential performance issue for the subset of the plurality of devices using aggregated metric data for the metric attribute that was generated using the metric data from the devices in the subset of the plurality of devices; determining, using at least a portion of the aggregated metric data, a portion of a code base or a hardware subcomponent that likely caused the potential performance issue; and providing, for presentation on a display, data for the portion of the code base or the hardware subcomponent that likely caused the potential performance issue.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include determining, for each device in the subset of plurality of devices, a software signature for code executed on the corresponding device when the metric data was generated; determining, using the software signatures, that the software signatures for the code executed on the devices in the subset of the plurality of devices satisfy a similarity criteria. Determining the potential performance issue for the subset of the plurality of devices can be responsive to determining that the software signatures satisfy the similarity criteria.

In some implementations, the method can include receiving, from each device in the subset of the plurality of devices, the corresponding software signature.

In some implementations, determining the portion of the code base or the hardware subcomponent that likely caused the potential performance issues can use the software signatures for the code executed on the devices in the subset of the plurality of devices.

In some implementations, determining the portion of the code base or the hardware subcomponent that likely caused the potential performance issues can include determining a counter that identifies the portion of the code base or the hardware subcomponent. Providing the data for the portion of the code base or the hardware subcomponent that likely caused the potential performance issue can include providing, for presentation on the display, the counter.

In some implementations, determining the potential performance issue can include: determining, using the metric data for the devices in the subset of the plurality of devices, a performance change in each device in the subset; determining, using data for the devices in the subset of the plurality of devices, a common context change; and determining the potential performance issue using the performance change in each device in the subset and the common context change.

In some implementations, determining the potential performance issue can include: determining, for each device in the subset of the plurality of devices, that at least some of the metric data for the corresponding device indicates a candidate performance issue for the corresponding device; in response to determining that at least some of the metric data for the corresponding device indicates the candidate performance issue for the corresponding device, generating, for each device in the subset of the plurality of devices, the corresponding software signature for code executed on the corresponding device when the metric data was generated; determining, using the software signatures, that the software signatures for the code executed on the devices in the subset of the plurality of devices satisfy a similarity criteria; and in response to determining that the software signatures satisfy the similarity criteria, determining that the candidate performance issues for the devices in the subset of the plurality of devices are likely the same performance issue.

In some implementations, determining that at least some of the metric data for the corresponding device indicates the candidate performance issue for the corresponding device can include determining that a likelihood that the corresponding device has the candidate performance issue satisfies a likelihood threshold.

In some implementations, the method can include in response to determining, using first metric data, that at least some of the first metric data for a first device indicates the candidate performance issue for the first device, requesting, from the first device, second metric data that is more detailed than the first metric data.

In some implementations, generating the corresponding software signature for the code executed on the first device when the metric data was generated can use the second metric data that is more detailed than the first metric data.

In some implementations, the method can include receiving, from a first device from the plurality of devices, corresponding metric data when the first device determines that a performance issue threshold is satisfied.

In some implementations, the metric data can include a log.

In some implementations, the context can be at least one of a hardware context or a software context.

In some implementations, determining the portion of the code base or the hardware subcomponent that likely caused the potential performance issue can include determining the portion of the code base, for code that was executed on a device from the plurality of devices or a system that provides one or more services to the device, that likely caused the potential performance issue.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can detect, e.g., using the aggregated metric data or signatures or both, performance issues with devices that might otherwise be difficult to detect. The performance issues can be issues with code, hardware, services (e.g., a subset of code), or a combination of these. For instance, a hardware issue might include a hardware component consuming a higher amount of power than it typically does. A service issue might indicate something that a carrier or another type of service provider should change in the configuration on a service provider system.

In some implementations, the systems and methods described in this specification can detect portions of code that likely caused performance issues. For instance, by using the described signatures, the systems and methods can more accurately detect problematic portions of code compared to other systems. In some instances, the systems and methods described in this specification can more quickly detect performance problems compared to other systems, e.g., using aggregate metric data, signatures, first metric data and second more detailed metric data, or a combination of two or more of these. In some implementations, the systems and methods described in this specification can more accurately detect performance issues for smaller populations of impacted devices compared to other systems. For instance, when a performance issue only occurs on one percent of devices sold, e.g., given a particular language, physical geographic region of use, or both, the use of the aggregate metric data, signatures, or both, can more accurately detect these performance issues. One example of a performance issue that can be detected in this way includes faster battery drain than would otherwise occur if the performance issue was fixed.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B depict an example of an environment in which a detection system detects performance issues for one or more devices.

FIG. 2 is a flow diagram of an example process determining a likely cause of a potential performance issue.

FIG. 3 is a block diagram of computing devices that may be used to implement the systems and methods described in this specification

Like reference numbers and designations in the various drawings indicate like elements.

### DETAILED DESCRIPTION

Devices can have performance issues, such as poor battery life, or suboptimal processor or network device usage. It can be difficult for a system to detect when multiple devices have the same issue, let alone identify a cause of the issue. For instance, when a single device has a performance issue that issue might be device specific, while when multiple devices have the same performance issue, the issue might require a more widely distributed fix.

To identify a performance issue, a system can aggregate metrics for the same attribute types from multiple devices in a larger set of devices. When any particular device has a performance issue, the system can generate a signature for the issue. The system can then cluster the signatures to determine issue subsets. An issue subset can include data for multiple potential performance issues each of which was determined for a corresponding device. As a result, an issue subset can represent a subset of devices that likely have the same issue. The system can analyze the issue subsets to determine how widespread an issue likely is, trends for the issues, e.g., is the issue increasing, or a combination of these.

The system can use signatures generated from code executing on a device for a time period during which the performance issue occurred. The duration of the time period can be selected using the duration of the performance issue. Given the signature, the system can determine what likely caused the performance issue. As a result, the signature is generally referred to in this specification as an “issue signature” that is specific to the issue, and the corresponding code executed on a device, and not the device from which the metric data was received. The cause can be a hardware cause, a software cause, or a combination of both. The cause can be on device or on another system, e.g., a server that provides data to the device, that provides network connectivity for the device, or a combination of both. When the cause is a software cause, the executed code can indicate a portion of a software library, e.g., a line of code in the library, that likely caused the performance issue. Presentation of the portion of the software library can enable a fix for the performance issue, e.g., by a developer or another system.

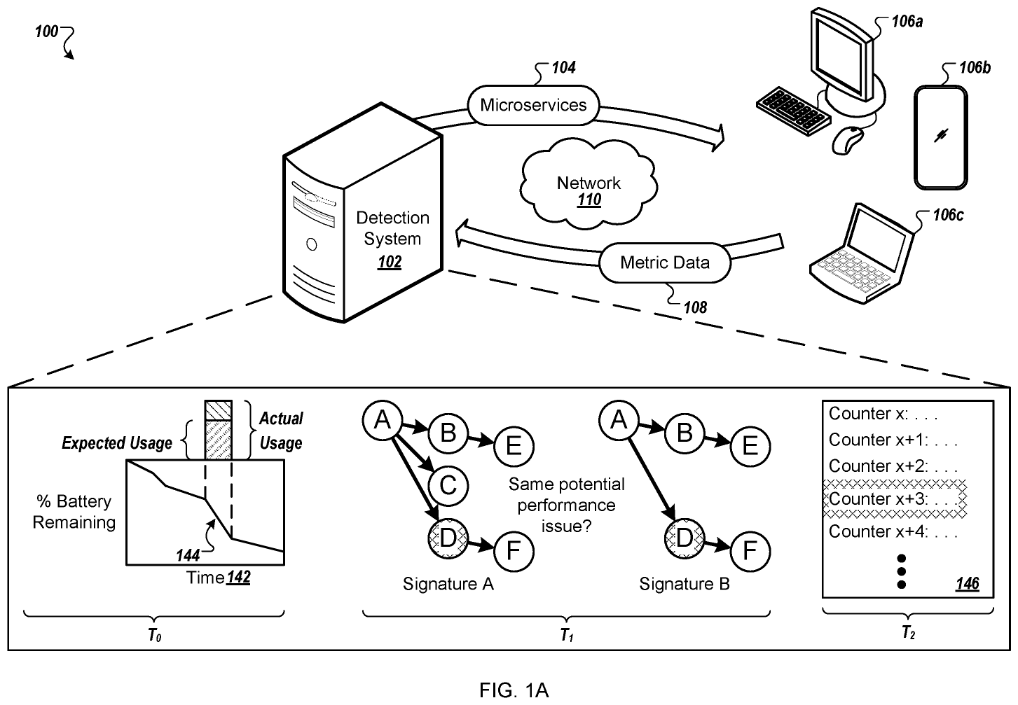

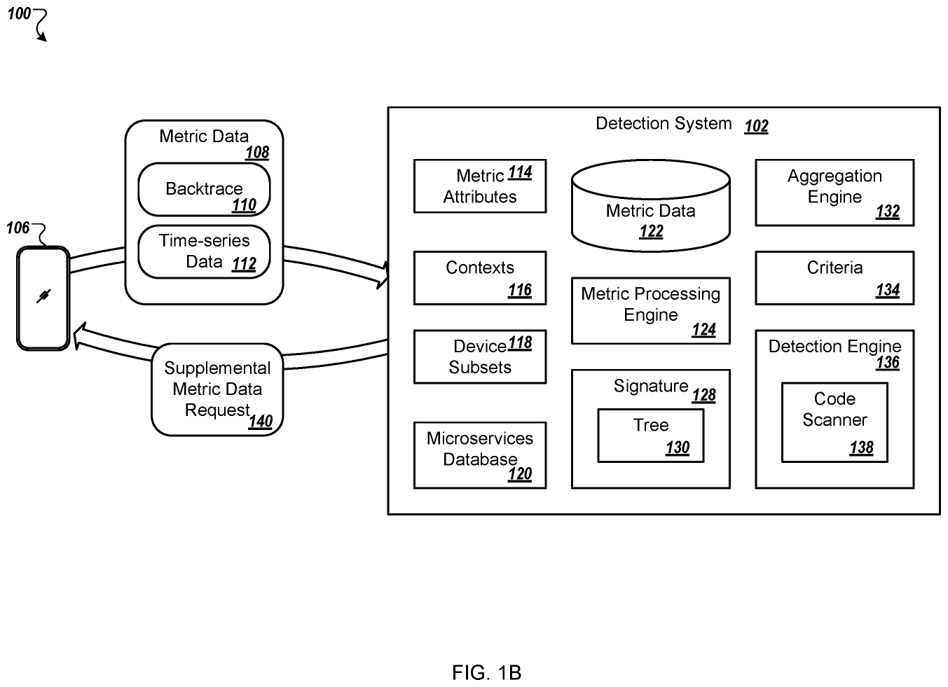

FIGS. 1A-B depict an example of an environment 100 in which a detection system 102 detects performance issues for one or more devices 106a-c. The detection system 102 can analyze data from multiple devices 106a-c, e.g., thousands, millions, or billions of devices, to detect performance issues that subsets of the devices 106a-c have. The detection system 102 can determine a likely cause of the performance issue and provide information, e.g., for display, about the performance issue. As a result, the detection system 102 can detect potential performance issues more quickly, accurately, or both, compared to other systems.

The detection system 102 can send microservices 104 to the devices 106a-c. The microservices can cause a recipient device to log data for a metric attribute from multiple metric attributes 114. For instance, a device 106 can have multiple metric attributes 114 such as battery metrics, CPU usage metrics, memory metrics, e.g., for random access memory or a longer-term memory such as a solid state drive, ambient light metrics, screen brightness metrics, network connectivity metrics, user activity metrics, executing application metrics, usage metrics, among others, or a combination of these. Since the device 106 would have reduced computational efficiency if the device 106 were to log data for each of these different metric attribute types, the detection system 102 can send a microservice 104 to the device that indicates the proper subset of metric attributes 114 that the device 106 should log, e.g., battery metrics.

The detection system 102 can determine the metric attributes 114 for which the detection system 102 should send a microservice 104 to a device 106, and the recipient device 106 should log metric data, using multiple contexts 116. A context 116 can indicate various information about the environment in which a device 106 might be used or details about the device 106 itself. For instance, some examples of contexts 116 can include a device model, an operating system, an operating system version, a geographic region in which the device is used at least a threshold amount, a language for the device, a carrier that provides service to the device 106, applications installed on the device 106, a system that provides data to the device 106, or a combination of these.

Using the contexts 116, the detection system 102 can determine multiple device subsets 118. Each of the devices in a device subset 118 has at least one common context, e.g., geographic region or operating system version. In some examples, a device is included in only a single device subset 118.

The detection system 102 can select a microservice 104 from the microservices database 120 for the device subset 118. The detection system 102 can send the same microservice 104 to each device in the device subset 118, including the device 106. As a result, the detection system 102 causes multiple devices in the device subset 118, that all have the at least one common context, to log metric data for a common metric attribute. This can reduce computational resource usage by not causing the device 106 to generate metrics for all metric attributes, but only a subset of metric attributes.

In some implementations, a device subset 118 is not the only subset with a particular common context. For instance, the detection system 102 can determine a first device subset for a particular geographic region, e.g., Africa, and a second device subset for the particular geographic region. The detection system 102 can assign, to each of these device subsets, a different metric attribute 114. For instance, the detection system 102 can determine to send the first device subset a microservice for battery metrics and the second device subset a microservice for ambient light metrics. In this way, the detection system 102 can cause devices with the common context to log different types of metric attributes. In some implementations, the detection system 102 can have a device subset 118 for each metric attribute 114 for the same particular context, e.g., to enable capture of all types of metric attributes 114 for the particular context.

After sending the microservices 104 to the devices 106a-c, the detection system 102 receives metric data 108 from at least some of the devices 106a-c. The metric data 108 can be any appropriate type of metric data, e.g., log data. For instance, the metric data 108 can include a backtrace 110, time-series data 112, or a combination of both. A backtrace 110 can be a snapshot of the code, e.g., the device stack, that was running on the device 106 during a time period. Some examples of backtraces can include a microstackshot, a microstack, stack trace, or a stackshot. The time-series data 112 can be a series of backtraces 110 captured over time or another appropriate series of data from the device 106 that indicates metrics for the corresponding metric attribute 114.

The detection system 102 can receive the metric data 108 at any appropriate time. For instance, the detection system 102 can receive the metric data 108 according to a schedule. In some examples, the detection system 102 can receive the metric data 108 when a device criterion is satisfied. For instance, when the device 106 determines that the device's performance likely is not optimized, e.g., when the device's battery is draining more quickly than expected according to the device criterion, the device 106 can send the metric data 108 to the detection system 102.

Referring to FIG. 1A, stage To indicates the device's remaining battery percentage across time for a time period 142. The time period can be any appropriate time period, such as a 12 or 24 hour time period. In this example, the device's remaining battery percentage declines within expected ranges, given the use of the device 106 and the applications executing on the device 106, throughout the time period 142 except during a time window 144 for which the actual battery usage was higher than the expected battery usage. As a result, the device 106 can determine that there was a potential performance issue during the time window 144 and provide the metric data 108, e.g., the one or more backtraces 110 for the time window 144, to the detection system 102. In examples in which the detection system 102 determines that there was a potential performance issue, the device 106 can provide the detection system 102 with the metric data 108. The detection system 102 can analyze the metric data 108 and determine that there was a potential performance issue during the time window 144.

The detection system 102 receives the metric data and stores the metric data in a metric database 122. The metric database 122 can store the data in a way that maintains privacy. For instance, the device 106 can generate the metric data 108 that does not have fingerprint-able data and provide the generated metric data to the detection system 102. The detection system 102 can then store the metric data 108 that does not have fingerprint-able data in the metric database 122 while maintaining device user privacy.

A metric processing engine 124 can access the metric data 108 from the metric database 122. The metric processing engine 124 analyzes the metric data 108. The metric processing engine 124 can determine whether the metric data 108 represents a potential performance issue. The metric processing engine 124 can perform any appropriate process to determine whether the metric data 108 represents a potential performance issue. For example, the metric processing engine 124 can use an artificial intelligence, e.g., machine learning, model to determine whether the metric data 108 represents a potential performance issue.

In some implementations, the detection system 102 can include multiple models. Each of the models can be associated with a different attribute from the metric attributes 114. When the detection system 102, e.g., the metric processing engine 124, accesses metric data, the detection system 102 can determine the metric attribute to which the metric data corresponds. The detection system 102 can use the metric attribute to select, from the multiple models, a model to use to determine whether the metric data represents a potential performance issue.

When the metric processing engine 124 determines that the metric data 108 likely does not represent a potential performance issue, the metric processing engine 124 can stop processing the metric data 108. For instance, the metric processing engine 124 can discard the metric data 108 or otherwise stop analyzing the metric data 108 for potential performance issues.

When the metric processing engine 124 determines that the metric data 108 likely represents a potential performance issue, the metric processing engine 124 can continue processing the metric data 108. For instance, the detection system 102 can generate a signature or perform another appropriate process as described below.

In some instances, the metric processing engine 124 can generate a signature 128 for the metric data 108. Since the metric data 108 is for the time window 144 in which a potential performance issue was detected, the signature 128 can be a signature for the potential performance issue.

In some implementations, the metric processing engine 124 can perform one or more additional processes on the received metric data 108. For instance, when the metric data 108 is included in a log, the metric processing engine 124 can extract the metric data 108 from the log and store the metric data in the metric database 122. In some examples, the metric processing engine 124 can extract the metric data 108 and generate a signature 128 for the metric data 108 in under seven seconds for most logs.

In some implementations, the signature 128 can represent the backtrace 110 of the code that was executing on the device 106 during the time window 144. For instance, the signature 128 can be a tree 130 that represents the code that was executing on the device 106 during the time window 144 with parent nodes indication which code initiated code for a child node. In some examples, the nodes can indicate counters that are called for execution of one or more applications during the time window 144.

During stage T₁, an aggregation engine 132 included in the detection system 102 can analyze data for the devices 106, e.g., metric data or the signatures 128 or a combination of both, for multiple potential performance issues to determine whether multiple devices 106 are likely having the same performance issue. For instance, as shown in FIG. 1A, the aggregation engine 132 can compare signature A and signature B to determine whether the signatures 128 likely represent the same performance issue. In the depicted example, the unexpected battery drain might be caused by the execution of code for nodes A, B, E, D, and F, though not necessarily in this order.

Since the detection system 102 includes the device subsets 118 for which devices in the same subset were sent the same microservice, e.g., to track the same metric attributes, the aggregation engine 132 can aggregate data for devices in a subset from the device subsets 118. For instance, instead of comparing first metric data for device A in a first subset and other metric for a device Z in a second subset, the aggregation engine 132 can compare the first metric data for the device A in the first subset and second metric data for device B in the first subset to determine whether the metric data, or signatures generated using the metric data, likely represent the same performance issue.

The aggregation engine 132 can use one or more criteria 134, e.g., similarity criteria, to determine whether metric data received from two devices, e.g., two signatures, likely represent the same performance issue. The criteria can be for a fuzzy matching process or any other appropriate process. The aggregation engine 132 can use fuzzy matching or a similar process, e.g., with a relaxed matching algorithm, when the metric data 108 is sample based and does not include all data for the time window 144, e.g., because of the lack of fingerprint-able data in the metric data 108.

The aggregation engine 132 can aggregate metric data that likely represents the same performance issue. For instance, when the aggregation engine 132 determines that two signatures likely represent the same performance issue, e.g., the same cause of the performance issue such as unexpected battery drain, the aggregation engine 132 can group data for the two signatures, e.g., and any other signatures that likely represent the same performance issue. For instance, the aggregation engine 132 can generate issue subsets that represent the metric data, received from multiple different devices, that likely represent the same potential performance issue. The issue subsets can include the signatures 128 for the corresponding metric data in the subset that was received from different devices, e.g., without any fingerprint-able data for the actual devices that generated the corresponding metric data 108.

In some implementations, the detection system 102 can determine whether multiple issue subsets satisfy a similarity criterion from the criteria 134. For instance, after aggregating metric data for potential performance issues for a first device subset from the device subsets 118 to generate a first issue subset, the detection system 102 can determine whether to aggregate metric data across different subsets from the device subsets 118. For example, the detection system 102 can determine whether the potential performance issue for the first issue subset is similar to another potential performance issue for a second issue subset, e.g., when the second issue subset was generated using data received from devices in a second device subset from the device subsets 118.

The aggregation engine 132 can use one or more signatures for the issue subsets to determine whether at least some of the signatures from the different issue subsets satisfy the similarity criterion. If so, the aggregation engine 132 can aggregate the two issue subsets into a single subset. In this way the detection system 102 can reduce computational resources necessary to generate subsets by making smaller subsets and then comparing data for those subsets to make a superset.

The detection system 102 can compare data for multiple issue subsets to determine if a potential performance issue is more widespread than the particular context for the device subset 118 in which the potential performance issue was detected. As a result, the detection system 102 can determine more accurate metrics related to a potential performance issue, and a potential cause of the performance issue. For example, if a first device subset is for a first geographic region, e.g., Africa, and a second device subset is for a first language, e.g., Spanish, and the detection system 102 determines that both device subsets likely have devices with the same potential performance issue, the detection system 102 can more accurately identify a potential cause of the performance issue using metric data for both subsets than using data for a single subset alone.

A detection engine 136, included in the detection system 102, analyzes issue subsets generated by the aggregation engine 132 to detect a potential cause of the potential performance issue. For instance, when the potential performance issue is a shortened battery life, the detection engine 136 can analyze metric data for the issue subset to detect a cause of the potential performance issue. The cause can be a software cause, a hardware cause, or a combination of both.

In some examples, the detection engine 136 can determine a portion of a code base, a hardware subcomponent, or a combination of both, that likely caused the potential performance issue. The detection engine 136 can determine a first counter that identifies the portion of the code base, a second counter that identifies the hardware subcomponent, or a combination of both, as a likely cause of the potential performance issue.

The detection engine 136 can use a potential performance issue signature to determine data for a likely cause of the potential performance issue. For instance, the detection engine 136 can, during stage T₂ shown in FIG. 1A, determine an identifier for a likely cause of the potential performance issue, e.g., reduced battery life. The detection engine 136 can use a backtrace 146 to determine the likely cause. The identifier can be a counter, e.g., the “counter x+3” that indicates a hardware subcomponent that was accessed during execution of the code, a portion of the code base that was executed, or a combination of both.

The potential cause can be either on the device 106 or system. For instance, when the device 106 receives a service or data from another system, e.g., a cellular provider or a server database, the counter can identify code, hardware, or both, on the other device or the other system that potentially caused the potential performance issue. As a result, the detection engine 136 can detect potential performance issues either on the device 106, or on another system with which the device 106 communicates.

The detection engine 136 can use a code scanner 138 to determine a cause of a potential performance issue. For instance, when the detection system 102 includes a copy of the source code to which a potential performance issue corresponds, e.g., as identified by the counter or other data in the backtrace, the code scanner 138 can determine one or more lines in the source code that are likely the cause of the potential performance issue.

In some implementations, the detection engine 136 can perform trend analysis for a potential performance issue. For instance, the detection engine 136 can determine whether a number of devices that likely have a particular performance issue is increasing or decreasing. When the number of devices is increasing, the detection engine 136 can determine that the potential performance issue is becoming more widespread and has not been fixed yet. This can include determining that any potential fixes have not worked, or have not fully worked. When the number of devices is decreasing, the detection engine 136 can determine that the potential performance issue might have been fixed, e.g., as devices install software updates that address the potential performance issue.

The detection engine 136 can generate presentation data that cause presentation of information about a potential performance issue. The presentation data can include instructions that, when received by a recipient device, cause presentation of a user interface. The user interface can be visible, audible, or both.

The presentation can include data about the potential performance issue, such as a type of the potential performance issue, e.g., unexpected battery drain. For instance, the presentation can indicate an application, a hardware subcomponent, or both, that likely caused the potential performance issue. This can include the counter that identifies the software component, the counter that identifies the hardware subcomponent, or both, that likely caused the potential performance issue.

In some examples, the presentation can include other appropriate types of data. For instance, the presentation can include trend analysis, snippets of software code, data about a third party, or a combination of these. The data about a third party can include data that identifies a hardware manufacturer for the hardware subcomponent, a service provider for the device 106, or another appropriate third party that might be related to the potential performance issue.

The detection engine 136 can provide data about the potential performance issue to a third party system. For instance, when the detection engine 136 determines that the hardware, software, or both, that are a likely cause of the potential performance issue were developed by a third party, e.g., instead of an entity that operates the detection system 102, the detection engine 136 can provide data about the potential performance issue to the third party system. The data can include the determined counters or other appropriate data about the potential performance issue. The third party can then use the received data to determine a fix to the potential performance issue.

In some implementations, the detection engine 136 can determine whether a potential performance issue is an actual performance issue, e.g., that is repeatable, fixable, or both. For instance, the detection engine 136 can determine whether the potential performance issue is likely representative of normal, although potentially changed, performance or not. For example, the detection engine 136 can determine whether the potential performance issue might be caused by what a user is doing, e.g., interacting with an interface or executing a number of applications that combined cause the potential performance issue in an expected manner.

The detection engine 136 can use one or more criteria 134 to determine whether the potential performance issue is an actual performance issue. For instance, the detection engine can use data for an issue subset, e.g., metric data such as signatures, to determine whether a potential performance issue for the issue subset is likely an actual performance issue.

In some implementations, the device 106, the detection system 102, or a combination of both, can determine a candidate performance issue. A candidate performance issue can be an issue that might suggest a performance issue but does not necessarily satisfy a criteria 134 for a potential performance issue, an issue detected for a single device or few devices, e.g., an amount that does not satisfy a quantity threshold, or a combination of these. For instance, a candidate performance issue might indicate, for a quantity of devices that does not satisfy the quantity threshold from the criteria 134, that the devices had a faster battery drain than expected.

In some examples, a candidate performance issue might satisfy some criteria but not others. For instance, a candidate performance issue might satisfy a lower threshold criterion while not satisfying a higher threshold criterion. The lower threshold criterion might be a criteria that indicates that the device 106 should provide metric data for the candidate performance issue to the detection system 102 even though the higher threshold criterion for determining a potential cause might not be satisfied. In some examples, the device can use a device criterion to determine whether to send data for a candidate performance issue to the detection system 102 while the detection system 102 uses a system criterion to determine whether data for the candidate performance issue should be aggregated with data received from other devices, is a potential performance issue, or both.

Upon determining that there is a candidate performance issue, the detection system 102 can determine whether there is sufficient data to indicate that the candidate performance issue is a potential performance issue. For example, the detection system 102 can determine whether the metric database 122, the signatures 128, or both, have other data indicating that other devices, e.g., of a sufficient quantity that satisfies the quantity threshold, likely have the same performance issue.

In some examples, the detection system 102 can send a supplemental metric data request 140 to the device 106. This request can cause the device 106 to provide more metric data 108 to the detection system 102. The additional metric data can include metric data for time windows around the time window 144 during which the device 106 likely had the performance issue, more data for the time window 144, or a combination of both. For instance, the device 106 can provide a subset of metric data 108 for the time window 144 to the detection system 102. If the detection system 102 determines that the subset of metric data 108 satisfies one or more criteria 134, e.g., to suggest a potential performance issue, the detection system 102 can request the supplemental metric data. As a result, the detection system 102 can reduce computational resources usage by getting a smaller amount of metric data first and then supplemental metric data only for potential performance issues and not all candidate performance issues.

In some implementations, the criteria 134 can include one or more criteria for the device subsets 118. The one or more criteria can indicate a criteria for the sizes of the subsets in the device subsets 118. The one or more criteria can include a maximum size, a minimum size, or both, for subsets in the device subsets 118. The one or more criteria can be fixed values, e.g., a number of devices, percentages, or a combination of both. The one or more criteria can apply to multiple contexts from the contexts 116, be specific to some a context from the contexts 116, or include a combination of both.

Although the above example describes unexpected battery drain as a potential performance issue, the detection system 102 can perform similar analysis for other types of potential performance issues, e.g., though optionally using different issue models. Some other examples include heat problems, slow scrolling, intermittent network disconnectivity, and high memory usage. In some examples, different types of potential performance issues, for different attributes, might have the same cause, e.g., when a cause increases processor usage, it might also increase device temperature.

As used in this specification, the detection system 102 can detect potential performance issues, e.g., instead of “performance issues”, given the uncertainty with which computers make decisions. Although a computer might make a binary decision, e.g., performance issue or no performance issue, this decision might, at times, be inaccurate, e.g., have false positives or false negatives.

The detection system 102 is an example of a system implemented as computer programs on one or more computers in one or more locations, in which the systems, components, and techniques described in this specification are implemented. The devices 106 can include personal computers, mobile communication devices, and other devices that can send and receive data over a network 148. The network, such as a local area network (“LAN”), wide area network (“WAN”), the Internet, or a combination thereof, connects the devices 106, and the detection system 102. The detection system 102 can use a single computer or multiple computers operating in conjunction with one another, including, for example, a set of remote computers deployed as a cloud computing service.

The detection system 102 can include several different functional components, including the metric processing engine 124, the aggregation engine 132, the detection engine 136, and the code scanner 138. The metric processing engine 124, the aggregation engine 132, the detection engine 136, the code scanner 138, or a combination of these, can include one or more data processing apparatuses, can be implemented in code, or a combination of both. For instance, each of the metric processing engine 124, the aggregation engine 132, the detection engine 136, and the code scanner 138 can include one or more data processors and instructions that cause the one or more data processors to perform the operations discussed herein.

The various functional components of the detection system 102 can be installed on one or more computers as separate functional components or as different modules of a same functional component. For example, the metric processing engine 124, the aggregation engine 132, the detection engine 136, and the code scanner 138 of the detection system 102 can be implemented as computer programs installed on one or more computers in one or more locations that are coupled to each through a network. In cloud-based systems for example, these components can be implemented by individual computing nodes of a distributed computing system.

Some examples of hardware subcomponents for the devices 106 can include a network subcomponent that provides network connectivity, a display, a battery, an input device, a processor, a gyroscope, an accelerometer, or a GPS subcomponent. Other types of subcomponents also apply.

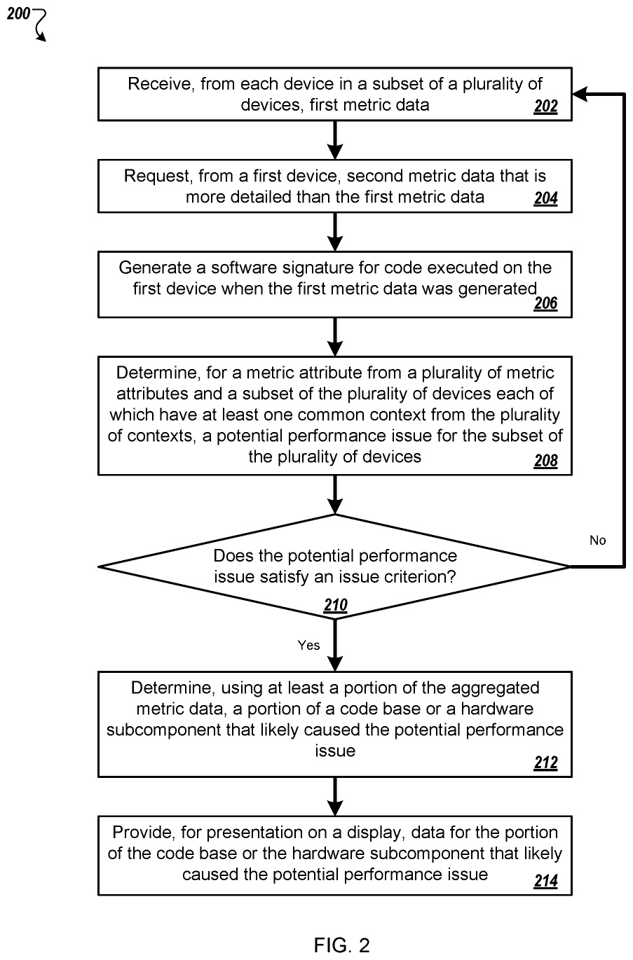

FIG. 2 is a flow diagram of an example process 200 for determining a likely cause of a potential performance issue. For example, the process 200 can be used by the detection system 102 from the environment 100.

A detection system receives, from each device in a subset of a plurality of devices, first metric data (202). For instance, the detection system can receive, as at least part of the first metric data, a software signature for the code executed on a corresponding device.

In some implementations, the detection system can receive the first metric data when a corresponding device determines that a performance issue threshold is satisfied. For instance, a device can provide some metric data when the performance issue threshold is satisfied instead of sending all metric data, e.g., given a microservice on the device that causes the device to generate metric data for a metric attribute. This can reduce network usage, e.g., for transmitting the metric data, memory usage, e.g., on the detection system since the detection system won't have to store all metric data, or both.

The detection system requests, from a first device, second metric data that is more detailed than the first metric data (204). For instance, the detection system can determine whether the first metric data satisfies one or more criteria for data analysis, e.g., that indicate an amount of data for analysis, whether a threshold likelihood of a potential performance issue is satisfied, or both. In response, the detection system can request second metric data. Based on the request, the detection system can receive the second metric data. The second metric data can be for metric data of the same attribute as the first metric data. In some examples, the second metric data can include a software signature for the code executed on a corresponding device.

The detection system generates a software signature for code executed on the first device when the first metric data was generated (206). For example, when the first metric data, the second metric data, or both, do not include a software signature, the detection system can generate the software signature.

The detection system determines, for a metric attribute from a plurality of metric attributes and a subset of the plurality of devices each of which have at least one common context from the plurality of contexts, a potential performance issue for the subset of the plurality of devices (208). The metric attribute can be battery life. The common context can be a device context, a physical region context, a third party context, or another appropriate context.

In some implementations, determining the potential performance issue can include determining a likelihood that a corresponding device, from which the metric data was received, has the performance issue. The detection system can determine the likelihood using the metric data.

In some implementations, when the detection system does not already have a signature for the potential performance issue, the detection system can generate the signature. For instance, in response to determining that at least some metric data for a device indicates a performance issue for the device, the detection system can generate the corresponding software signature, e.g., the issue signature, for code executed on the device when the metric data was generated.

In some examples, the detection system can determine, as the potential performance issue, a performance change. This can be a change caused by a software update. The change can indicate a new trend in resources used by the software application that was updated, e.g., which change might not be represented by a current model for the software application and might suggest a potential performance issue. The detection system can determine a performance change for the devices in the subset, e.g., using metric data for the devices. The detection system can determine, using data for the devices in the subset of the plurality of devices, a common context change. The common context change can be a service provider change, a language change, or a geographical region change, to name a few examples. The detection system can determine the potential performance issue using the performance change in each device in the subset and the common context change.

The detection system determines whether the potential performance issue satisfies an issue criterion (210). For instance, the detection system can determine whether the likelihood satisfies a likelihood threshold. When the issue criterion is not satisfied, the detection system can determine to skip further analysis of the potential performance issue, e.g., at least at this time though the analysis might change upon receipt of additional data from additional devices if the issue criterion is a quantity related threshold. Some examples of issue criterion can include criteria that indicate a likelihood of determining a fix for the potential performance issue, a likelihood that the potential performance issue is an actual performance issue, e.g., that is not caused by a software update or a device user or both, or another appropriate criterion.

In some implementations, when the detection system had sufficient data to determine a potential performance issue but might not have sufficient data to determine a likely cause of the potential performance issue, the detection system can request the second metric data after determining the potential performance issue, or determining that the potential performance issue satisfies the issue criterion.

The detection system determines, using at least a portion of the aggregated metric data, a portion of a code base or a hardware subcomponent that likely caused the potential performance issue (212). For instance, the detection system determines a likely cause of the potential performance issue. The detection system can determine one or more counters. The one or more counters can identify the portion of the code base, e.g., a line in the code, a hardware subcomponent, or both, e.g., with multiple counters.

In some implementations, the detection system might not know the exact portion of the code base to which the counter refers. For instance, the detection system might not have access to any code for applications executing on the devices, or have access to only a subset of code for applications executing on the devices. In these instances, though the detection system has the counter, the detection system might not know the corresponding code to which the counter refers, e.g., when it does not have access to the corresponding code. This can occur when the code is for a third party system, e.g., a server with which the device communicates, a third party application, or a combination of both. For example, the code can be code that was executed on a device from the plurality of devices or a system that provides one or more services to the device.

The detection system provides, for presentation on a display, data for the portion of the code base or the hardware subcomponent that likely caused the potential performance issue (214). For instance, the data can include the counter or other data that identifies the likely cause of the potential performance issue.

The order of operations in the process 200 described above is illustrative only, and determining the likely cause of the potential performance issue can be performed in different orders. For example, the device can generate the software signature and then the detection system can receive the software signature, e.g., as part of the first metric data.

In some implementations, the process 200 can include additional operations, fewer operations, or some of the operations can be divided into multiple operations. For example, the process 200 can include operations 208, 212, and 214, optionally with operation 202 or maintenance of metric data or both, without any of the other operations. The process 200 can include operations 202-204, 208, 212, and 214 without any of the other operations. In some examples, the process 200 can include operation 206 in combination with any of the above lists of operations.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” refers broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

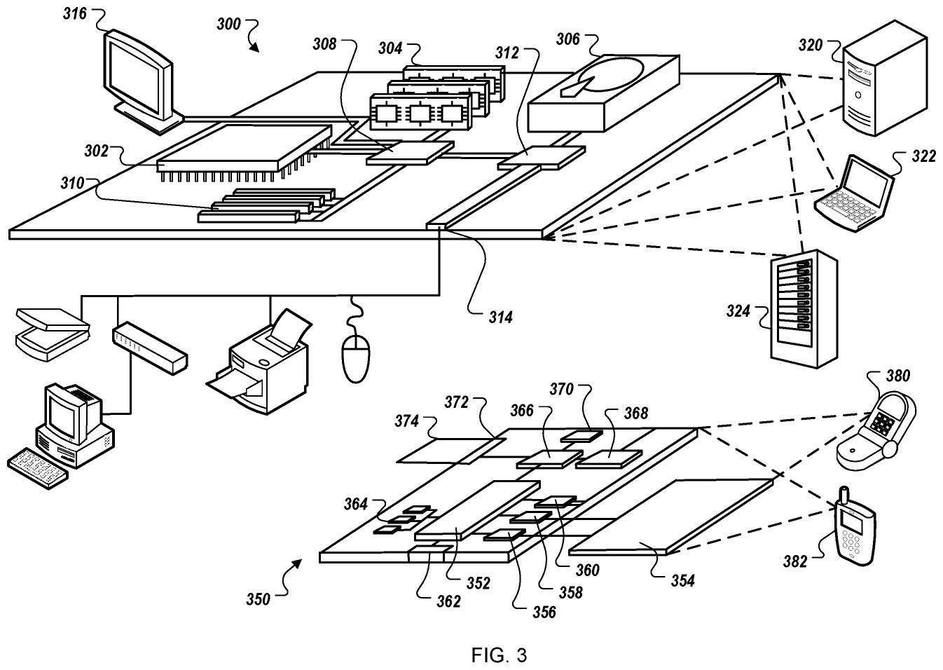

FIG. 3 is a block diagram of computing devices 300, 350 that may be used to implement the systems and methods described in this specification, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 300 includes a processor 302, memory 304, a storage device 306, a high-speed interface 308 connecting to memory 304 and high-speed expansion ports 310, and a low-speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a computer-readable medium. In one implementation, the memory 304 is a volatile memory unit or units. In another implementation, the memory 304 is a non-volatile memory unit or units.

The storage device 306 is capable of providing mass storage for the computing device 300. In one implementation, the storage device 306 is a computer-readable medium. In various different implementations, the storage device 306 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 304, the storage device 306, or memory on processor 302.

The high-speed controller 308 manages bandwidth-intensive operations for the computing device 300, while the low-speed controller 312 manages lower bandwidth-intensive operations. Such allocation of duties is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can process instructions for execution within the computing device 350, including instructions stored in the memory 364. The processor may also include separate analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD display or an OLED display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, for wired communication (e.g., via a docking procedure) or for wireless communication (e.g., via Bluetooth or other such technologies).

The memory 364 stores information within the computing device 350. In one implementation, the memory 364 is a computer-readable medium. In one implementation, the memory 364 is a volatile memory unit or units. In another implementation, the memory 364 is a non-volatile memory unit or units. Expansion memory 374 may also be provided and connected to device 350 through expansion interface 372, which may include, for example, a SIMM card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provided as a security module for device 350, and may be programmed with instructions that permit secure use of device 350. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 364, expansion memory 374, or memory on processor 352.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS receiver module 370 may provide additional wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
maintaining, for a plurality of devices at least some of which have different contexts from a plurality of contexts, metric data for an application that executed on each of the plurality of devices;
determining, for a metric attribute from a plurality of metric attributes and a subset of the plurality of devices each of which have at least one common context from the plurality of contexts, a potential performance issue for the subset of the plurality of devices using aggregated metric data for the metric attribute that was generated using the metric data from the devices in the subset of the plurality of devices;
determining, using at least a portion of the aggregated metric data, a portion of a code base or a hardware subcomponent that likely caused the potential performance issue; and
providing, for presentation on a display, data for the portion of the code base or the hardware subcomponent that likely caused the potential performance issue.

2. The method of claim 1, comprising:
determining, for each device in the subset of plurality of devices, a software signature for code executed on the corresponding device when the metric data was generated;
determining, using the software signatures, that the software signatures for the code executed on the devices in the subset of the plurality of devices satisfy a similarity criteria, wherein determining the potential performance issue for the subset of the plurality of devices is responsive to determining that the software signatures satisfy the similarity criteria.

3. The method of claim 2, comprising receiving, from each device in the subset of the plurality of devices, the corresponding software signature.

4. The method of claim 2, wherein determining the portion of the code base or the hardware subcomponent that likely caused the potential performance issues uses the software signatures for the code executed on the devices in the subset of the plurality of devices.

5. The method of claim 2, wherein:
determining the portion of the code base or the hardware subcomponent that likely caused the potential performance issues comprises determining a counter that identifies the portion of the code base or the hardware subcomponent; and
providing the data for the portion of the code base or the hardware subcomponent that likely caused the potential performance issue comprises providing, for presentation on the display, the counter.

6. The method of claim 1, wherein determining the potential performance issue comprises:
determining, using the metric data for the devices in the subset of the plurality of devices, a performance change in each device in the subset;
determining, using data for the devices in the subset of the plurality of devices, a common context change; and
determining the potential performance issue using the performance change in each device in the subset and the common context change.

7. The method of claim 1, wherein determining the potential performance issue comprises:
determining, for each device in the subset of the plurality of devices, that at least some of the metric data for the corresponding device indicates a candidate performance issue for the corresponding device;
in response to determining that at least some of the metric data for the corresponding device indicates the candidate performance issue for the corresponding device, generating, for each device in the subset of the plurality of devices, the corresponding software signature for code executed on the corresponding device when the metric data was generated;
determining, using the software signatures, that the software signatures for the code executed on the devices in the subset of the plurality of devices satisfy a similarity criteria; and
in response to determining that the software signatures satisfy the similarity criteria, determining that the candidate performance issues for the devices in the subset of the plurality of devices are likely the same performance issue.

8. The method of claim 7, wherein determining that at least some of the metric data for the corresponding device indicates the candidate performance issue for the corresponding device comprises determining that a likelihood that the corresponding device has the candidate performance issue satisfies a likelihood threshold.

9. The method of claim 7, comprising:
in response to determining, using first metric data, that at least some of the first metric data for a first device indicates the candidate performance issue for the first device, requesting, from the first device, second metric data that is more detailed than the first metric data, wherein:
generating the corresponding software signature for the code executed on the first device when the metric data was generated uses the second metric data that is more detailed than the first metric data.

10. The method of claim 1, comprising:
receiving, from a first device from the plurality of devices, corresponding metric data when the first device determines that a performance issue threshold is satisfied.

11. The method of claim 1, wherein the metric data comprises a log.

12. The method of claim 1, wherein the context comprises at least one of a hardware context or a software context.

13. The method of claim 1, wherein determining the portion of the code base or the hardware subcomponent that likely caused the potential performance issue comprises determining the portion of the code base, for code that was executed on a device from the plurality of devices or a system that provides one or more services to the device, that likely caused the potential performance issue.

14. A system comprising one or more computers and one or more storage devices on which are stored instructions that are operable, when executed by the one or more computers, to cause the one or more computers to perform operations comprising:
maintaining, for a plurality of devices at least some of which have different contexts from a plurality of contexts, metric data for an application that executed on each of the plurality of devices;
determining, for a metric attribute from a plurality of metric attributes and a subset of the plurality of devices each of which have at least one common context from the plurality of contexts, a potential performance issue for the subset of the plurality of devices using aggregated metric data for the metric attribute that was generated using the metric data from the devices in the subset of the plurality of devices;
determining, using at least a portion of the aggregated metric data, a portion of a code base or a hardware subcomponent that likely caused the potential performance issue; and
providing, for presentation on a display, data for the portion of the code base or the hardware subcomponent that likely caused the potential performance issue.

15. The system of claim 14, the operations comprising:
determining, for each device in the subset of plurality of devices, a software signature for code executed on the corresponding device when the metric data was generated;
determining, using the software signatures, that the software signatures for the code executed on the devices in the subset of the plurality of devices satisfy a similarity criteria, wherein determining the potential performance issue for the subset of the plurality of devices is responsive to determining that the software signatures satisfy the similarity criteria.

16. The system of claim 15, the operations comprising receiving, from each device in the subset of the plurality of devices, the corresponding software signature.

17. The system of claim 15, wherein determining the portion of the code base or the hardware subcomponent that likely caused the potential performance issues uses the software signatures for the code executed on the devices in the subset of the plurality of devices.

18. The system of claim 15, wherein:
determining the portion of the code base or the hardware subcomponent that likely caused the potential performance issues comprises determining a counter that identifies the portion of the code base or the hardware subcomponent; and
providing the data for the portion of the code base or the hardware subcomponent that likely caused the potential performance issue comprises providing, for presentation on the display, the counter.

19. The system of claim 14, wherein determining the potential performance issue comprises:
determining, using the metric data for the devices in the subset of the plurality of devices, a performance change in each device in the subset;
determining, using data for the devices in the subset of the plurality of devices, a common context change; and
determining the potential performance issue using the performance change in each device in the subset and the common context change.

20. One or more non-transitory computer storage media encoded with instructions that, when executed by one or more computers, cause the one or more computers to perform operations comprising:
maintaining, for a plurality of devices at least some of which have different contexts from a plurality of contexts, metric data for an application that executed on each of the plurality of devices;
determining, for a metric attribute from a plurality of metric attributes and a subset of the plurality of devices each of which have at least one common context from the plurality of contexts, a potential performance issue for the subset of the plurality of devices using aggregated metric data for the metric attribute that was generated using the metric data from the devices in the subset of the plurality of devices;
determining, using at least a portion of the aggregated metric data, a portion of a code base or a hardware subcomponent that likely caused the potential performance issue; and
providing, for presentation on a display, data for the portion of the code base or the hardware subcomponent that likely caused the potential performance issue.
